(19) United States
(12) Patent Application Publication
(10) Pub. No.: US 2010/0229552 A1
(43) Pub. Date: Sep. 16, 2010

(54) DEVICE AND METHOD FOR GAS ENRICHMENT OR GENERATION OF MECHANICAL POWER

(75) Inventors: Michael Baune, Bremen (DE); Jörg Thöming, Bremen (DE); George Okoth, Bremen (DE); Andreas Varesi, Munich (DE)

Correspondence Address: MERCHANT & GOULD PC, P.O. BOX 2903, MINNEAPOLIS, MN, 55402-0903, US

(73) Assignee: Universitat Bremen, Bermen (DE)

(21) Appl. No.: 12/722,325

(22) Filed: Mar. 11, 2010

(30) Foreign Application Priority Data
Mar. 13, 2009 (DE) 10 2009 013 138.8

(51) Int. Cl. F01K 13/00; F17D 1/04

(52) U.S. Cl. 60/645; 137/2; 137/334

(57) ABSTRACT

The present invention relates to a device comprising:
a first container and a second container,
   a capillary device arranged between the first container and the second container with one or more capillaries, each of the one or more capillaries connecting the first container to the second container, and each of the one or more capillaries tapering at least in sections from the second container in the direction towards the first container,
   means for generating and/or maintaining a temperature gradient T_{1st container}>T_{2nd container} between the first container and the second container.

This application claims benefit of Serial No. 10 2009 013 138.8, filed 13 Mar. 2009 in Germany and which applications are incorporated herein by reference. To the extent appropriate, a claim of priority is made to each of the above disclosed applications.

### BACKGROUND

The present invention relates to a device suitable in particular for gas enrichment or for the generation of mechanical power by means of a gas, as well as to the corresponding method.

Such a generic device is known from DE 10 2005 055 675 B3. The invention described there comprises, for example, two containers connected to each other by a capillary device. The capillary device comprises one or more capillaries, whereby each of the one or more capillaries tapers at least in sections from one side to the other side of the capillary device.

### SUMMARY

The permeation of gases in pores can be described by the three mechanisms of gas permeation known for decades, namely size exclusion, solution diffusion, and Knudsen diffusion. The first two are used, inter alia, in membrane separation. For the separation by size exclusion, molecular sieves with a pore diameter well below 1 nanometre are used. The separation, which is at times very specific, leads to very high selectivities and low permeability at the same time. In solution diffusion, the gas dissolves in a polymer fabric and diffuses. Depending on the polymer, a large range of selectivities and permeabilities can be covered, whereby an improvement of one variable always comes at the expense of the other variable.

In the state of the art, the gases exhibit different behaviour at the capillary device and, in particular, pass through the capillaries at different rates if the containers are filled with a gas or a gas mixture. On the one hand, this may result in the enrichment of one gas component of a gas mixture in one of the containers; on the other hand, it may result in a pressure difference between the two containers, which can be used to generate a mechanical power. With regard to the exact functioning of the device of the state of the art, reference may be made to DE 10 2005 055 675 B3.

What is essential for the device described in DE 10 2005 055 675 B3 is that the minimum cross-sectional area of each of the one or more capillaries is smaller at least in one direction than the predetermined mean free path of the gas. The geometry of the pores and the differences in the mean free paths of the gases of a gas mixture are indicated to be sufficient to achieve a desired effect.

It has now been found, though, that for the operation of the device from the state of the art, there is, on the one hand, no driving power to drive a method to be implemented with the device. On the other hand, it has been found that the gas enrichment and/or the generation of mechanical power that can be achieved with the device from the state of the art is still insufficient. Furthermore, the operation of the device described in the state of the art has shown that the geometry of the capillary device described there does not lead to a sufficient separation of the gas mixture.

It is therefore an object of the present invention to provide a device that overcomes the disadvantages known from the state of the art and that makes it possible, in particular, to improve the enrichment of a gas component in a gas mixture and to further advance the use of a difference in pressure for generating mechanical power.

Furthermore, an object is to provide methods for gas enrichment and for the generation of mechanical power which employ the device according to the invention.

The first object is solved by a device comprising:
a first container and a second container, a capillary device arranged between the first container and the second container with one or more capillaries, each of the one or more capillaries connecting the first container to the second container, and each of the one or more capillaries tapering at least in sections from the second container in the direction towards the first container,
means for generating and/or maintaining a temperature gradient T_{1st container}>T_{2nd container} between the first container and the second container.

It is proposed that the first container and/or the second container is/are filled with gas.

Furthermore, it may be provided that the device comprises at least one gas supply line for supplying a gas and at least one gas discharge line for discharging a gas.

It is also preferred that the at least one gas supply line is connected to the first and/or second container and/or that the at least one gas discharge line is connected to the first and/or second container.

It is preferred that the second container is connected to a device for generating mechanical power or that the device for generating mechanical power is integrated in the second container.

Furthermore, it is preferred that the second container is connected to a device for generating mechanical power or that the device for generating mechanical power is integrated in the second container.

It is particularly preferred that the second container is open to the ambient atmosphere.

Moreover, it is advantageously provided that the length of each of the one or more capillaries is between 10 μm and 3 cm.

According to a particular embodiment of the invention it is provided that the diameter of the opening of each of the one or more capillaries is 0.05-5 μm on the side of the first container and that the diameter of the opening of each of the one or more capillaries is 0.5 to 100 μm at the second container.

It is advantageous for the angle α in the tapered section of each of the one or more capillaries between a capillary wall and the angle bisector to be <45°, and preferably to be between 0.001 and 10°.

Particularly preferably, the means for generating a temperature gradient is a heating device at or inside the first container.

It may also be provided that the means for generating a temperature gradient comprises a cooling device at or inside the first container.

It is also preferred that the first container and the second container should be thermally separated from each other.

In addition, the material of the first container may be different from the material of the second container.

According to a preferred embodiment, the Knudsen number (Kn) of the capillary device is between 1>Kn>0.005, preferably 1>Kn>0.01, the diameter of the pore at the tapered end being used for determining the Knudsen number.

As a particularly preferred embodiment, it is provided that the temperature gradient is an average of 0.1° C. to 800° C., preferably 0.5-100° C.

A further embodiment of the invention provides a method for gas enrichment of a predetermined gas from a gas mixture, comprising the following steps:
introducing a gas mixture containing a predetermined gas into the first container
setting a temperature gradient T_{1st container}>T_{2nd container} between the first container and the second container with the means for generating and/or maintaining a temperature gradient, and
discharging the predetermined gas or a gas mixture in which the predetermined gas is enriched from the first container.

It is preferred in this embodiment that several devices are connected in series.

It is also preferred that at least some of the predetermined gas from the second container is fed back into the first container.

Finally, the present invention provides a method for generating mechanical power by means of a device, comprising the steps:
introducing a gas into the first container, setting a temperature gradient T_{1st container}>T_{2nd container} between the first container and the second container with the means for generating and/or maintaining a temperature gradient, and
guiding the gas from the second container into and/or through a device for generating mechanical power.

It has surprisingly been found in accordance with the invention that it is essential for the device known from DE 10 2005 055 675 B3 to provide a temperature gradient between the first and the second containers so that the temperature in the first container is higher than the temperature in the second container. This requires only a low temperature gradient so that the pressure does not rise in the first container—as would have been expected—but does in the second container. This effect (i.e. raising the temperature of the first container compared to the second container and the resulting pressure increase in the second container) had not been expected at all but has the consequence that the device according to the invention can be used much better in a method for gas enrichment or generation of mechanical power.

In addition, it has been found in accordance with the invention that it is preferable for the gas-specific interaction of the molecules with the wall to play an important role. Compared to the interaction of the gas molecules with one another, the wall effect is the more pronounced the higher the Knudsen number is; i.e. the ratio of the mean free path of the gas molecules to the pore diameter. It is particularly preferred for the Knudsen number (Kn) to be between 1>Kn>0.005. This is in contrast to the findings of DE 10 2005 055 675 B3, according to which it is always a Knudsen number of >1 that must be provided so that the minimum cross-sectional area of each of the one or more capillaries is smaller in at least one direction than the predetermined mean free path. It has also been found in accordance with the invention that the device known from the state of the art does not follow the equation “angle of incidence=angle of deflection” described there. The reflection at the walls can therefore not be described according to Newtonian mechanics but is rather based on the Knudsen cosine law.

While the device known from the state of the art is especially suitable for monomolecular gases, it has been found in accordance with the invention that, by contrast, particularly good results for the separation of carbon dioxide (CO₂) are achieved when using the described device for gas enrichment.

The gas enrichment can be optimised by systematically selecting the material of the capillary device.

It is preferred that the pore diameter is larger than the mean free path by a factor of 10 to 100, so that the mean free path only plays a minor role in the use of the device according to the invention and the proposed methods.

It has been found in accordance with the invention that gas-specific interactions with the pore wall have a considerable influence on the behaviour of the gases in the capillary device, a temperature gradient having been identified as the driving power for the methods according to the invention.

### BRIEF DESCRIPTION OF THE DRAWINGS

Some preferred embodiments of the present invention will be explained below with reference to the enclosed Figures, in which

FIG. 1 shows a graph which illustrates the dependence of the pressure difference Δp on the temperature gradient ΔT during the operation of a device according to the invention,

FIG. 2 shows a schematic illustration of a device according to the invention that can be used for gas enrichment, and

FIG. 3 shows a schematic illustration of a further device according to the invention that can be used for generating mechanical power.

### DETAILED DESCRIPTION

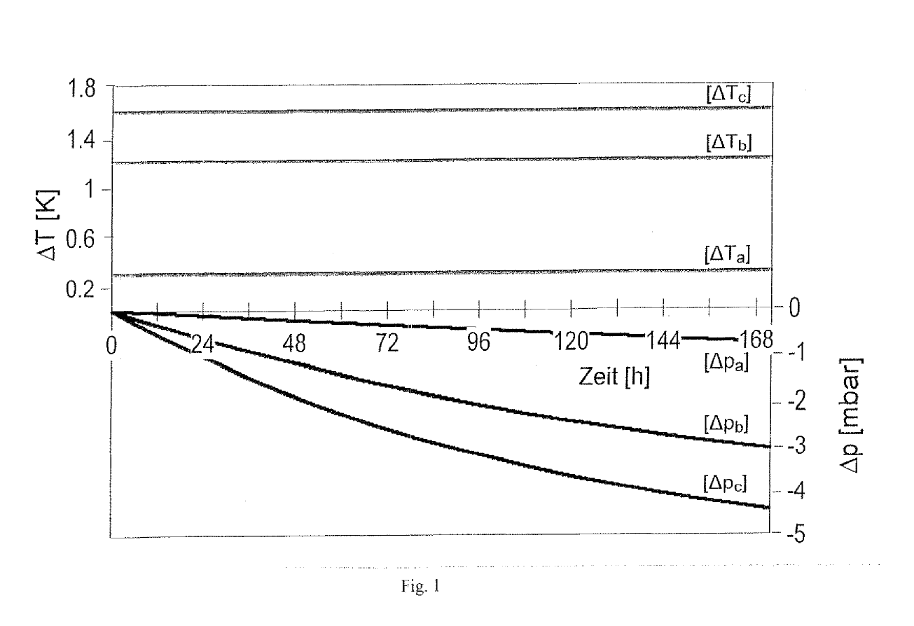

For a device according to the invention, the dependence between the set temperature gradient and the resulting pressure difference between the first container and the second container was determined with a gas during the operation of the device. The results are shown in FIG. 1, the upper part of FIG. 1 showing the applied mean temperature difference ΔT, where T_{1st container}>T_{2nd container}. The lower part of FIG. 1 shows the pressure difference Δp, where p_{1st container}<p_{2nd container} which results from this temperature difference. It can be gathered from FIG. 1 that very small temperature differences already lead to significant pressure differences which can be exploited.

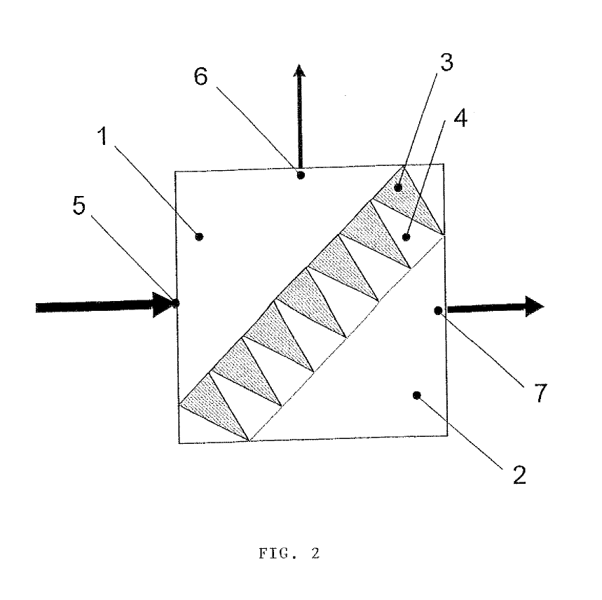

FIG. 2 schematically shows a device for gas enrichment according to the invention which—in a simplified illustration—consists of a first container 1 and a second container 2, the two of them being connected to each other by a capillary device 3. The capillary device 3 shows a multitude of capillaries 4 which taper from the second container 2 in the direction towards the first container 1. It is of course possible for the capillaries 4 to taper in sections inside the capillary device 3. Corresponding shapes of capillaries are known from DE 10 2005 055 675 B2, for example. The device shown in FIG. 2 further comprises a means (not shown) for generating and/or maintaining a temperature gradient T_{1st container}>T_{2nd container} between the first container 1 and the second container 2. This means helps to ensure that the temperature in the first container 1 is on average constantly higher than the temperature in the second container 2. A gas supply line 5 leads into the first container 1 and can be used to feed a gas mixture into the first container 1. A gas discharge line 6 leads out of the first container 1 and can be used to remove a depleted gas mixture from the first container. Finally, the second container 2 shows a gas discharge line 7 through which enriched gas and/or concentrate can be removed.

In the operation of the device illustrated in FIG. 2, a gas mixture is guided, preferably continuously, through the gas supply line 5 into the first container 1. The means for generating and/or maintaining a temperature gradient (not shown) raises the temperature in the first container above the temperature in the second container 2 and/or keeps it high, which results in an increase in pressure in the second container 2. During this process, a depleted gas mixture can be removed from the first container 1 through the gas discharge line 6. Furthermore, an enriched gas and/or concentrate can be removed from the second container 2 through the gas discharge line 7. This enriched gas can be circulated again into the first container 1 of the same device, for example, or it can be guided into a further device for gas enrichment connected in series so as to enhance the gas enrichment still further. It is obvious that a multitude of devices for gas enrichment can be connected in series.

The features of the device in conjunction with the means for generating and/or maintaining the temperature gradient ensure that the gas to be enriched shows a higher permeation rate with regard to the capillary device 3 than other components of the gas mixture to be separated. As has been stated above, the temperature gradient in particular serves as a driving power so that a gas enrichment can be implemented in the device according to the invention.

The means for generating and/or maintaining a temperature gradient can be a heating device, for example, arranged inside the first container 1. However, it can also be considered for such a means to cool the second container 2 with a cooling device (not shown), for example. The heating device and the cooling device can also be used jointly. Finally, it may also be provided that the second container 2 is insulated from the ambient atmosphere. For the method according to the invention, mere variations in the ambient temperature are then sufficient to achieve the effect of the pressure increase in the second container 2 due to a temperature gradient between the first and second containers 1, 2, as described above.

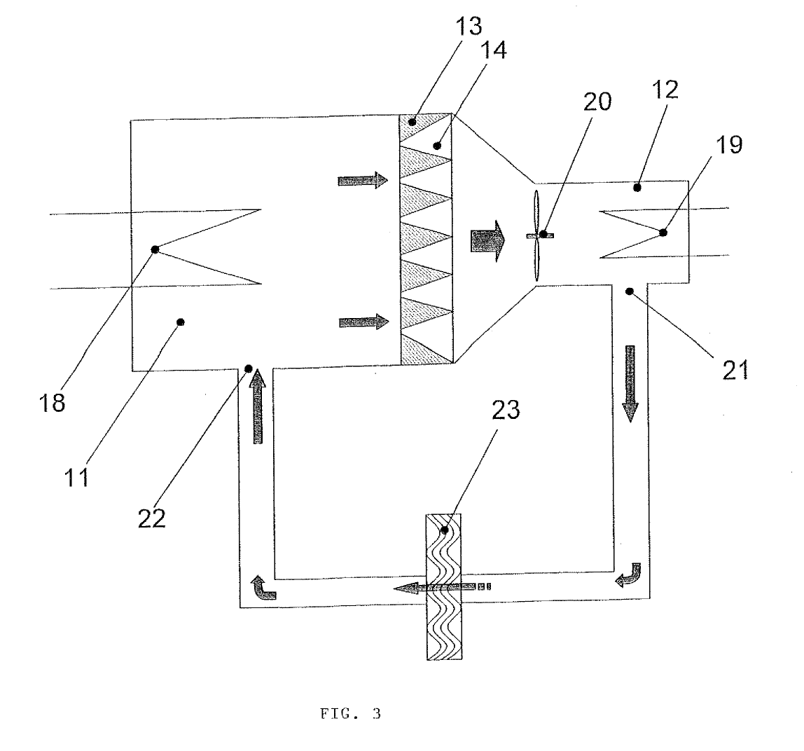

It is obvious that FIG. 2 (and also FIG. 3 which will be described below) are merely schematic illustrations and are not true to scale. In particular, capillaries 4 and their lateral dimensions are not shown true to scale.

Finally, FIG. 3 shows a further device according to the invention that can be used for generating mechanical power.

A first container 11 is connected to a second container 12 by a capillary device 13. The capillary device 13 shows a multitude of capillaries 14 which taper from the second container 12 in the direction towards the first container 11. A means 18 for generating and/or maintaining a temperature difference, preferably a heating device, is arranged at the first container 11. A further means 19 for generating and/or maintaining a temperature difference, preferably a cooling device, is arranged at the second container 12. Furthermore, a means 20 for generating mechanical power, a rotor or a turbine for example, is arranged in the second container 12 in the flow path of the gas. The first container 11 and the second container 12 are also connected to each other by a connecting line comprising an outlet 21 from the second container 12 and an inlet 22 into the first container 11. In this connecting line, a means 23 is furthermore provided for thermally separating the first container 11 and the second container 12.

In the operation of the device shown in FIG. 3, a temperature difference T_{1st container}>T_{2nd container} between the first container 11 and the second container 12 is set and maintained. The temperature difference can be achieved by heating a gas in the first container 11 and/or cooling the gas in the second container 12. This temperature difference causes gas to flow from the first container 11 into the second container 12, thus leading to a pressure increase in the second container 12. The flow of the gas can be used to drive the rotor 20, which is disposed in the second container 12 in the flow path of the gas, and thus to generate mechanical power. The gas can then be guided from the second container 12 through the outlet 21 and the inlet 22 back into the first container 11. Here, it is essential for the first container 11 and the second container 12 to be thermally separated from each other.

The features of the invention disclosed in the description, in the claims and in the drawings can be essential to implementing the invention in its most varied embodiments both individually and in combination.

1. A device, comprising:
a first container and a second container,
a capillary device arranged between the first container and the second container with one or more capillaries, each of the one or more capillaries connecting the first container to the second container, and each of the one or more capillaries tapering at least in sections from the second container in the direction towards the first container, and
means for generating and/or maintaining a temperature gradient T_{1st container}>T_{2nd container} between the first container and the second container.

2. The device as claimed in claim 1, wherein the first container and/or the second container is/are filled with gas.

3. The device as claimed in claim 1, further comprising at least one gas supply line for supplying a gas and at least one gas discharge line for discharging a gas.

4. The device as claimed in claim 3, wherein the at least one gas supply line is connected to the first and/or second container and/or the at least one gas discharge line is connected to the first and/or second container.

5. The device as claimed in claim 1, wherein the second container is connected to a device for generating mechanical power or that the device for generating mechanical power is integrated in the second container.

6. The device as claimed in claim 1, wherein the second container is connected to a device for expanding gas or that the device for expanding gas is integrated in the second container.

7. The device as claimed in claim 1, wherein the second container is open to the ambient atmosphere.

8. The device as claimed in claim 1, wherein the length of each of the one or more capillaries is between 10 μm and 3 cm.

9. The device as claimed in claim 1, wherein the diameter of the opening of each of the one or more capillaries is 0.05-5 μm on the side of the first container and that the diameter of the opening of each of the one or more capillaries is 0.5 to 100 μm at the second container.

10. The device as claimed in claim 1, wherein the angle α in the tapered section of each of the one or more capillaries between a capillary wall and the angle bisector is <45°, preferably between 0.001 and 10°.

11. The device as claimed in claim 1, wherein the means for generating a temperature gradient comprises a heating device at or inside the first container.

12. The device as claimed in claim 1, wherein the means for generating a temperature gradient comprises a cooling device at or inside the second container.

13. The device as claimed in a claim 1, wherein the first container and the second container are thermally separated from each other.

14. The device as claimed in claim 1, wherein the material of the first container is different from the material of the second container.

15. The device as claimed in claim 1, wherein the Knudsen number (Kn) of the capillary device is between 1>Kn>0.005, preferably 1>Kn>0.01.

16. The device as claimed in claim 1, wherein the temperature gradient is an average of 0.1° C. to 800° C., preferably 0.5-100° C.

17. A method for gas enrichment of a predetermined gas from a gas mixture by means of a device as claim 1, comprising the following steps:
introducing a gas mixture containing a predetermined gas into the first container
setting a temperature gradient T_{1st container}>T_{2nd container} between the first container and the second container with the means for generating and/or maintaining a temperature gradient, and
discharging the predetermined gas or a gas mixture in which the predetermined gas is enriched from the first container.

18. The method as claimed in claim 17, wherein a plurality of the devices are connected in series.

19. The method as claimed in claim 17, wherein at least some of the predetermined gas from the second container is guided back into the first container.

20. A method for generating mechanical power by means of a device as claimed claim 1, comprising the following steps:
introducing a gas into the first container,
setting a temperature gradient T_{1st container}>T_{2nd container} between the first container and the second container with the means for generating and/or maintaining a temperature gradient, and
guiding the gas from the second container into and/or through a device for generating mechanical power.
